(19) United States
(12) Patent Application Publication
(10) Pub. No.: US 2016/0330541 A1
(43) Pub. Date: Nov. 10, 2016

(54) AUDIO DUPLICATION USING DUAL-HEADSETS TO ENHANCE AUDITORY INTELLIGIBILITY

(71) Applicant: Jeffrey Miao, Saratoga, CA (US)

(72) Inventor: Jeffrey Miao, Saratoga, CA (US)

(73) Assignee: AliphCom, San Francisco, CA (US)

(21) Appl. No.: 14/705,908

(22) Filed: May 6, 2015

(51) Int. Cl. H04R 1/10

(52) U.S. Cl. CPC H04R 1/1083; H04R 1/1091; H04R 2460/01; H04R 2430/01

(57) ABSTRACT

A pair of wireless of discrete wireless headsets may wirelessly link with each other. At least a portion of data representing content (e.g., audio information) may be received by a first wireless headset and may be communicated to a second wireless headset via the wireless link (e.g., a radio frequency link). The first wireless headset may receive the data representing the content from an internal data store (e.g., non-volatile memory), or from a wired and/or a wireless communications link between the first wireless headset and an external device (e.g., a smartphone, a tablet, a content streaming device, etc.). Ambient noise may impair auditory intelligibility of audio information included in the data representing the content when the audio information is presented only on the first wireless headset. Impaired auditory intelligibility may be mitigated by presenting the audio information on both the first and second wireless headsets to enhance auditory intelligibility.

### FIELD

Embodiments of the present application relate generally to electrical and electronic hardware, computer software, wired and wireless communications, and radio frequency systems. More specifically, embodiments of the present application relate to portable wireless devices, signal processing, audio transducers, motion sensing, and consumer electronic (CE) devices.

### BACKGROUND

A user of a wireless headset, such as those used in conjunction with smartphones, cellular phones, tablets, pads, laptop computers, desk top computers, and the like may often opt to have at least two such wireless headsets. Additional headsets may be carried by the user in case battery power in the headset currently donned by the user becomes low or otherwise insufficient for powering the headset. For example, based on a current remaining power reserves for the battery (e.g., as displayed on bars or percentage on a wireless device or verbally communicated by the headset to the user) a lengthy phone conversation may not be possible and the user may deem it prudent to swap out the current headset for one with a full charge or more having more remaining power reserves than the current headset. An example of such a user may include a business person, a professional, or a traveler.

Often a user may have a headset over which content is being presented (e.g., being broadcast as audio over a speaker of the headset) to the user; however, due to high ambient noise levels (e.g., in a car with the windows down or a noisy public area), the user may not be able to hear the conversation, or audio generally, with an acceptable degree of auditory intelligibility, and may often resort to plugging a free ear (e.g., an ear not having the donned headset) with a finger or earplugs, for example, in an attempt to block and/or attenuate the ambient noise entering the free ear. However, although plugging of the free ear may provide a moderate improvement in auditory intelligibility, the ambient noise may still overshadow/overwhelm the content being presented even if a volume level of the headset is turned up to a maximum level.

Accordingly, there is a need for systems, apparatus and methods for improving intelligibility of audio content.

### BRIEF DESCRIPTION OF THE DRAWINGS

Various embodiments or examples (“examples”) are disclosed in the following detailed description and the accompanying drawings:

FIG. 1 depicts one example of a flow chart for enhancing auditory intelligibility;

FIG. 2 depicts an example of a pair of donned headsets;

FIG. 3 depicts an example of a block diagram for a wireless headset;

FIG. 4 depicts different views of a wireless headset and associated components;

FIG. 5 depicts different examples of earpieces that may be used with a wireless headset;

FIG. 6 depicts an example of a pair of donned wireless headsets and examples of volume levels for each wireless headset; and

FIG. 7 depicts one example of an application for a pair of wireless headsets.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored or otherwise fixed in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

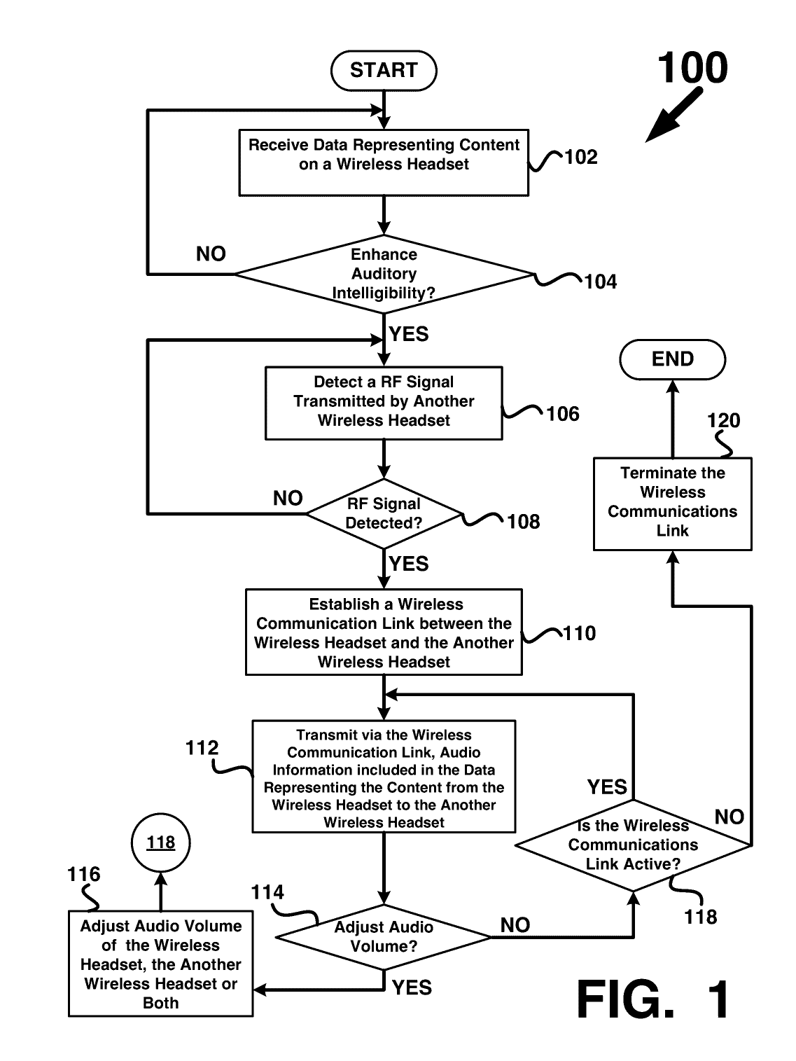

FIG. 1 depicts one example of a flow 100 for enhancing auditory intelligibility (e.g., in a presence of ambient noise). Flow 100 may be implemented using circuitry and/or a non-transitory computer readable medium that includes program instructions and/or data operative to execute on one or more compute engines (e.g., a processor, controller, μP, μC, DSP, FPGA, ASIC, etc.). Examples of the non-transitory computer readable medium may include but is not limited to electronic memory, RAM, DRAM, ROM, EEPROM, Flash memory, and non-volatile memory, for example. The non-transitory computer readable medium may be distributed over a plurality of devices as will be described below (e.g., a pair of wireless headsets and/or a wireless device).

At a stage 102, one of a pair of wireless headsets (headset one hereinafter) may receive data representing content (e.g., audio information included in the data representing the content). The data representing the content (content hereinafter) may be communicated to headset one using a wireless communications link between headset one and an external wireless computing device (e.g., a smartphone, a cellular phone, a tablet, a pad, a server, a laptop computer, a gaming device, etc.). The wireless communications link may constitute one or more wireless communications protocols, including, but not limited to, one or more varieties of IEEE 802.x, Bluetooth (BT), BT Low Energy (BTLE), WiFi, WiMAX, Cellular, Software-Defined-Radio (SDR), HackRF, and Near Field Communication (NFC), AdHoc WiFi, short range RF communication, long range RF communication, for example. At the stage 102, headset one may be donned (e.g., worn, put on, or otherwise mounted or coupled with an ear) and may be activated (e.g., powered-up and optionally linked with an external device). In some examples, headset one may already be donned and/or be already activated. In other examples, headset one may already be activated. In yet other examples, the content may be communicated to headset one via a wired communications link (e.g., a cable) between headset one and an external device. In some examples, the content may be accessed from a data store internal to headset one (e.g., a non-volatile memory).

At a stage 104, a determination may be made as to whether or not to enhance auditory intelligibility (e.g., to enhance auditory intelligibility in the presence of ambient noise that may otherwise degrade auditory intelligibility). If a YES branch is taken from stage 104, then flow 100 may transition to another stage, such as a stage 106, for example. If a NO branch is taken from the stage 104, then flow 100 may transition to another stage, such as back to stage 102, for example.

At the stage 106, headset one may be activated to detect a radio frequency (RF) signal transmitted by another wireless headset (headset two hereinafter) in the pair of wireless headsets. The taking of the YES branch from the stage 104 to the stage 106 may trigger activation of a radio in headset one that is configured to detect the RF signal transmitted by headset two (e.g., by a radio in headset two). Headset one and headset two may have been previously wirelessly paired or otherwise wirelessly linked with each other. Activation of headset two may constitute powering-up headset two or may constitute headset two transitioning from a stand-by state (e.g., a low-power consumption state) to an activated state (e.g., a fully-powered state). A RF system in headset two may detect a RF signal generated by headset one and upon detection of the RF signal may transition from the stand-by state to the activated state. Either headset may detect a RF signal from the other headset and may wirelessly link with each other or may be caused to enter a discoverable state in preparation for wireless linking or pairing, for example. Headset one and headset two may include one or more radios configured to wirelessly communicate using one or more wireless communications protocols, for example.

At a stage 108, a determination may be made as to whether or not the RF signal has been detected. Detection of the RF signal may constitute headset one detecting the RF signal of a wireless computing device in communication with headset one (e.g., a linked or paired smartphone, etc.). After headset one has detected the RF signal, headset one may wirelessly communicate data representing detection of the RF signal. The data representing detection of the RF signal may be communicated to headset two, the wireless computing device or both, for example.

Headset one may not detect the RF signal due to one or more factors, including, but not limited to headset two being outside a RF detection range of headset one, a RF power (e.g., in dBm) of the RF signal being below a threshold value for detection by a RF system of headset one, insufficient received signal strength indicator (RSSI) of the RF signal, just to name a few. If a NO branch is taken, then flow 100 may transition to another stage, such as back to the stage 106, for example, to make additional attempts to discover the RF signal. If a YES branch is taken from the stage 108, then flow 100 may transition to another stage, such as a stage 110, for example.

At the stage 110, headset one and headset two may establish a wireless communications link with each other. In some examples, establishing the wireless communications link may occur automatically. Automatic establishment of the wireless communications link may be due to a previous linking or paring of headset one and headset two with each other, a previous linking or paring of headsets one and two with an external wireless computing device (e.g., a client device), for example. A prior linking or pairing between headset one and headset two may have generated data representing a unique address or identifier (e.g., a BT address, MAC address, etc.) for each headset that may be stored in a data store (e.g., non-volatile memory) and may be electronically accessed (e.g., by a read operation to a memory or data store) during the stage 110 to determine if the data representing the unique address matches a list of previously linked or paired devices. Here, headset one and headset two may include the unique address of each other in a data store and that address is accessed to determine if headset one and headset two recognize each other from a previous linking or paring. In other examples, establishing the wireless communications link may occur manually (e.g., as in a manual paring or linking operation) by activating one or more buttons, switches or the like, and/or by using a GUI, drop down menu, application (APP) or other interface on a client device (e.g., a smartphone, pad, tablet, laptop, smart watch, or other types of wireless devices).

At a stage 112, audio information (audio data hereafter) included in the data representing the content received by headset one may be wirelessly transmitted to headset two using the wireless communication link established at the stage 110. The audio data may constitute speech data or voice data (e.g., from a telephonic conversation, VoIP conversation, phone conference call, etc.). In some examples, the audio data may be associated with other data or data such as video, music, multi-media, text, a game, a movie, an image, etc. The audio data may constitute analog signals, digital signals or both, for example. Headsets one and two may include hardware and/or software to decode and/or encode the audio data into format that is transmitted at the stage 112. Digital data may be transmitted in packets or some other format. The data representing the content may include one or more channels of audio (e.g., mono, stereo, multi-channel, etc.) and the audio data may include voice, speech, conversation (e.g., a telephonic conversation), a sound track, or music, for example.

At a stage 114 a decision may be made as to whether or not to adjust a volume of the audio playback in headset one, headset two or both. In some examples, the volume may be approximately the same in headset one and headset two. In other examples, the volume may be different in headsets one and headset two. As one example, if a level of ambient noise (e.g., in dB) being received (e.g., ambient acoustic energy incident on 202) by headset two (e.g., by one or more microphones in headset two) is greater than the a level of ambient noise (e.g., in dB) being received (e.g., ambient acoustic energy incident on 201) by headset one (e.g., by one or more microphones in headset one), then a volume of the audio being presented by headset two may be at a higher volume than a volume of audio being presented by headset one. Alternatively, if a level of ambient noise (e.g., in dB) being received by headset one is greater than the a level of ambient noise (e.g., in dB) being received by headset two, then a volume of the audio data being presented by headset one may be at a higher volume than a volume of the audio data being presented by headset two. As another example, if a level of ambient noise being received by headsets one and two is equal or approximately equal, then a volume of the audio presented by headset one and headset two may be approximately equal to each other (e.g., approximately doubling a perceived volume of voice, music, or other information in the audio data). In that there may be differences (e.g., slight differences) in performance of audio systems in headsets one and two, sound output levels from transducers (e.g., speakers) that present the audio data to each ear of the user may not be exactly the same. In some examples, circuitry that couples the audio signal to amplifiers that drive first and second speakers in headset one and headset two, respectively, may set identical output levels for the audio signals coupled to the amplifiers (e.g., using a digital volume control). As described herein, presenting of the audio data may constitute an amplifier receiving an analog signal representing the audio data, amplifying the analog signal, and driving an audio transducer (e.g., one or more speakers) coupled with the amplifier with the amplified audio signal. In some examples, multiple amplifiers may drive multiple audio transducers (e.g., bi-amping, tri-amping, etc.). In other examples, audio data in content being handled by headset one may be duplicated and wirelessly transmitted to headset two. Duplicated audio data may be presented (e.g., played back) on headset two with the same or different volume level than headset one.

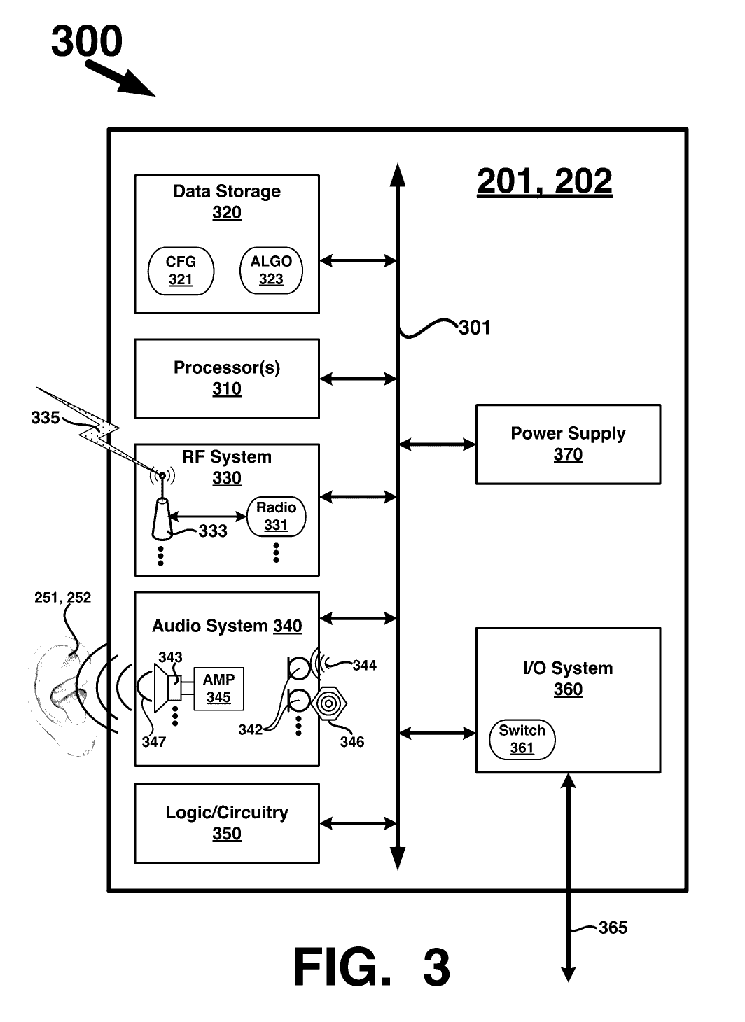

The audio data may be is acoustically communicated via an air pressure wave in time synchronization to audio transducers (e.g., speakers) in headset one and headset two without an audibly perceptible time delay. The time synchronization may be accomplished by adding a time delay to the audio data being received by headset one, headset two or both. For example, in that headset one may be transmitting the audio data to headset two, there may be some latency associated with the audio data being received by headset two, processed by headset two, and presented by headset two to the ear of the user, for example. If that latency is approximately 20 milliseconds, then headset one may delay presentation of its audio data by approximately 20 milliseconds, for example. Here, whatever time synchronization process is used, there may still be some amount of exact time synchronization between headsets one and two; however, deviations in synchronicity in time may be permissible so long as the deviation in synchronicity in time are not audibly perceptible, that is, the ar/brain system perceives no difference in time synchronization in the audio data being presented to the ears. Although headset one has been described as transmitting the audio data to headset two, in other examples, headset two may transmit the audio data to headset one. Headset two may delay presentation of its audio data to headset one to address latency as described above. Latency may include but is not limited to one or more of propagation time, packet delivery time, processing delay (e.g., by a processor in headset one, headset two or both), ping time (e.g., roundtrip time from headset one sending a transmission to a time headset one receives an acknowledgment signal, data, ping response or acknowledgement packet from headset two), link roundtrip time, network throughput, link throughput (e.g., wireless link between headset one and headset two), and message delivery time, just to name a few, for example. As one example, headset one may calculate latency based on a determination of ping time. Further to the example, if ping time is approximately 20 milliseconds, headset one may compute the latency as being a fraction of the ping time (e.g., one-half (0.5) of the ping time) and delay playback of audio data on its speaker (see 343 in FIG. 3) by the fraction of the ping time (e.g., by approximately 10 milliseconds). In some examples, an acknowledgement signal, packet or other data from headset two may constitute a smaller portion of the ping time due to packet delivery time, processing delay or other factors constituting a larger portion of the ping time; therefore, if ping time is approximately 24 milliseconds, headset one may compute the latency as being a larger fraction of the ping time (e.g., 0.8 of the ping time) and headset one may delay playback of audio data on its speaker by approximately 19 milliseconds.

If a YES branch is taken from the stage 114, then flow 100 may transition to another stage, such as a stage 116, for example. At the stage 116 a volume of the audio data may be adjusted for headset one, headset two or both. If a NO branch is taken from the stage 114, then flow 100 may transition to another stage, such as a stage 118, for example. At the stage 118 a determination may be made as to whether or not headsets one and/or two are still activated. Here, not being activated may include headset one, headset two or both, being turned off (e.g., by activating a switch or pressing power button), being activated to a low power or standby power state, no longer being donned (e.g., removed from an ear), a near field communication distance (e.g., an approximate ear separation distance) between headset one and headset two that may be necessary to maintain the wireless communications link between headset one and headset two may have been exceeded and/or interrupted by some structure or medium that affects RF signals, or a command or signal may have caused de-activation of one or both of the headsets (e.g., from an APP running on an external device), for example.

If a YES branch is taken from the stage 118, then flow 100 may transition to another stage, such as the stage 112 where audio data may continue to be transmitted, for example. If a NO branch is taken from the stage 118, then flow 100 may transition to another stage, such as the stage 120 where the wireless communication link between headsets one and two may be terminated, for example. Alternatively, the flow 100 may transition to the stage 106 where headset one may attempt to discover headset two, for example.

As will be described in greater detail below, headsets one and/or two may include an earpiece, earbud, earloop, eartips, or other structure connected (e.g., removeably connected) with the headset and operative to mount or otherwise couple the headset with an ear of a user and to position an audio transducer to acoustically couple sound generated by the audio transducer with the ear (e.g., the ear drum via the ear canal). The earbud or other structure may be in contact with one or more portions of the outer ear, auricle, pinna, ear canal, or some combination of the foregoing. Headsets one and two may be identical makes and/or models of headsets, such as those manufactured by the JAWBONE® Corporation or other manufactures, for example. In some examples, headsets one and two may be manufactured by the same company but may be different models of headsets. In other example, headsets one and two may be different makes and/or models of headsets manufactured by different companies.

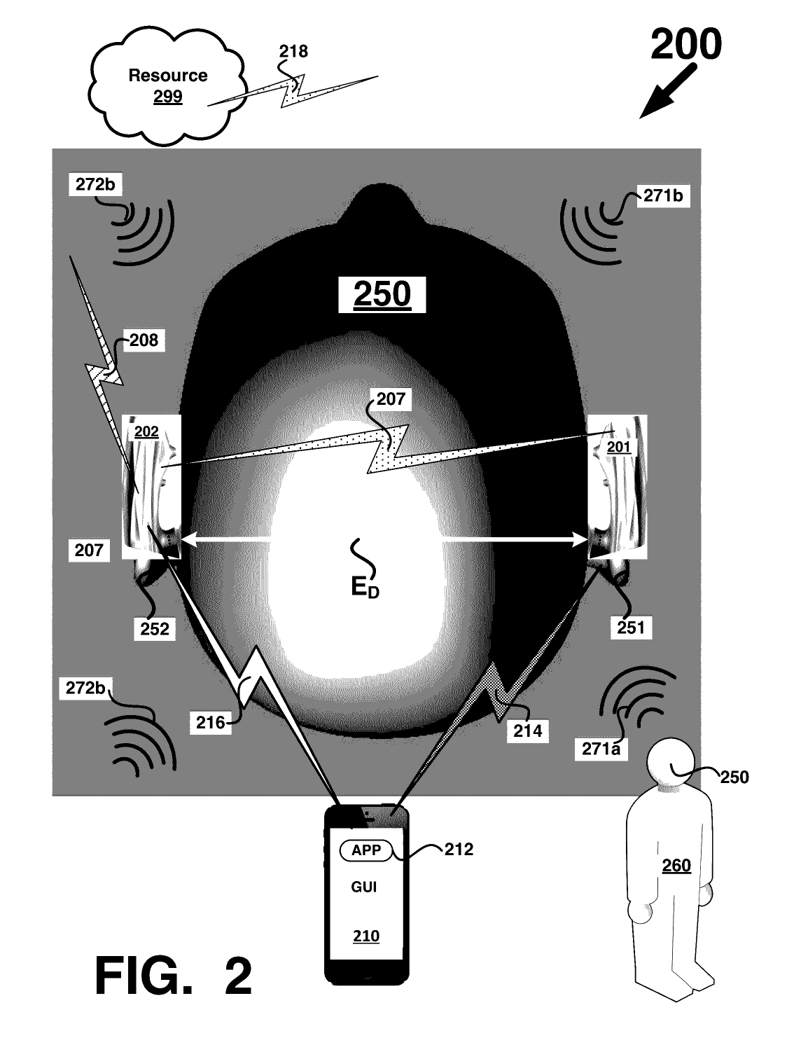

FIG. 2 depicts an example 200 of a pair of donned headset. For purposes of explanation the pair of donned headsets may be denoted as headset one 201 and headset two 202. Headsets one and two (201,202) are not connected with each other by a structure (e.g., a band or a wire) and may be separate, distinct, and independent wireless headsets. Headsets one and two (201,202) may be configured to be wearable wireless devices that are donned on an ear (e.g., ear-donned) of a head 250 or a user 260, for example. As is described below, a structure such as an earpiece, earbud, eartip, earloop or the like may be connected with headsets one and two (201,202) and may be operative to mount, don, or otherwise couple headsets one and two (201,202) with one of the two ears (251, 252). Headset one 201 may be donned on first ear 251 and headset two 202 may be donned on second ear 252, or vice-versa. However, for purposes of explanation, headset one 201 is donned on the first ear 251 and headset two 202 is donned on second ear 252.

Initially, headset one 201 may be activated (e.g., turned on, powered up, awakened) and may be already donned on the head 250 and in wireless communication 214 with an external device, such as client device 210 (e.g., a smartphone, a tablet, a pad, a laptop, etc.). For example, headset one 201 may be linked and/or paired with wireless device 210 and data representing content constituting a telephonic conversation (e.g., from a phone call or VoIP call) may be processed by client device 210 with at least audio data included in the data representing the content being presented to right ear 251 via headset one 201 (e.g., by a speaker in headset 201). However, one or more sources of ambient noise (271a, 271b, 272a, 272b) incident on right ear 251, left ear 252 or both may make it difficult for the user 260 to hear the audio data with sufficient audio intelligibility. Accordingly, headset two 202 may be activated (e.g., turned on, powered up, awakened) and donned on the left ear 252, for example. Activating the second headset 202 may generate a RF signal 208 that is detected by headset one 201, the client device 210 or both. Upon detection (e.g., as described above for flow 100 of FIG. 1) a wireless communications link 207 may be established between headsets one and two (201, 202) and at least a portion of the content being (e.g., audio data) wirelessly communicated 214 from the client device 210 to headset one 201 may be transmitted by headset one 201 to headset two 202 via the wireless communications link 207. Volume levels of headset one 201 and/or headset two 202 will be described in greater detail below in regards to volume levels in general and volume levels set according to one or more sources of ambient noise (271a, 271b, 272a, 272b) that may be detected by transducers included in an audio system of headset one 201, headset two 202 or both.

Headset two 202 may have previously been linked or paired with client device 210 as denoted by communications link 216; however, the previous linking/pairing 216 may be ignored or overridden by headset two 202 when headset one 201 is already activated and in communication (e.g., 214) with the client device 210 prior to activation and/or donning of headset two 202. Client device 210 may include an application (APP) 212 that may control one or more functions of headsets one and two (201, 202), such as foregoing establishing link 216 with headset two 202 when headset one 201 has been previously activated and is currently linked 214 with the client device 201, for example. A graphical user interface (GUI) on a display (e.g., a touchscreen, LCD, OLED) of client device 210 may include icons, menu selections, drop down boxes etc. that may be selected to implement functions of APP 212, such as controlling the above mentioned one or more functions of headsets one and two (201, 202).

The data representing the content may originate from a location (e.g., a data store, Flash memory) internal to wireless device 210 and/or another location, such as resource 299 (e.g., the Internet, a Cloud source, NAS, a web site, a web page, wireless access point, etc.) that is in communication 218 with the client device 210, headset one 201, or both. The data representing the content, regardless of its source may include various types of data in a packet or other data structures suitable for wired and/or wireless communication. Packets may include the audio data, data payloads, header fields, time indexes, error detection and/or correction fields, etc.

Headsets one and two (201, 202) when donned on ears (251, 252) of head 250 may be spaced apart from each other by approximately an ear separation distance E_{D}, that may be in a range from about 10 cm to about 24 cm (e.g., about 30 cm or less) for typical human head sizes, for example. Actual spacing between headsets one and two (201, 202) may vary from the above example and the present application is not limited to the above example. The range of distances for ear separation distance E_{D} may vary with heads shapes and/or sizes, for example. The ear separation distance E_{D} may be a distance that headset one 201 and headset two 202 are configured to wirelessly communicate with each other via link 207, such that for a distance that is greater than a maximum allowable ear separation distance E_{D} (e.g., a distance of about 30 cm or more) may exceed a short range RF communications distance between headsets 201 and 202, and the link 207 between headsets 201 and 202 may be broken, may be weak (e.g., below an acceptable RF power level for reliable data communications) for accurate communication of the audio data, for example. One or more radios in headsets one and two (201, 202) may be configured to establish link 207 using a short range wireless protocol and/or near field wireless protocol, such as Bluetooth (BT), Bluetooth Low Energy (BTLE) or near field communication (NFC). For example, if headsets one and two (201, 202) are spaced apart by a distance of approximately 2×E_{D}, then that distance may exceed the distance for reliable short range or near field RF communications and link 207 may be ineffective, severed or otherwise rendered ineffectual.

FIG. 3 depicts an example of a block diagram 300 for a wireless headset. Block diagram 300 depicts one example of an implementation of headset one 201, headset two 202, or both. Systems and components of headsets one and two (201, 202) may be electrically coupled with each other using a bus 301 or other electrically conductive structure for electrically communicating signals. Headsets one and two (201, 202) may have systems including but not limited to: a processor(s) 310; data storage 320; a RF system 330; an audio system 340; logic/circuitry (e.g., analog and/or digital); an I/O system 360; and a power supply 370.

Processor(s) 310 may constitute one or more compute engines and the processor(s) 310 may execute algorithms and/or data embodied in a non-transitory computer readable medium, such as algorithms (ALGO) 323 and/or configuration (CFG) 321 in data storage 320. Processor(s) 310 may include but are not limited to one or more of a processor, a controller, a μP, a μC, a DSP, a FPGA, and an ASIC, for example. Data storage 320 may constitute one or more types of electronic memory such as Flash memory, non-volatile memory, RAM, ROM, DRAM, and SRAM, for example. Data storage 320 may include the data representing the content. The data representing the content may be stored in data storage 320 as a file or other format. For example, the data representing the content may be a file including but not limited to an MP3 file, MPEG-4 file, MP4 container, ALAC file, FLAG File, AIFF file, AAC file, and WAV file, etc., just to name a few. The data representing the content may be received (e.g., via wired and/or wireless link) by the wireless headset and may be buffered and/or stored in data storage 320.

Configuration (CFG) 321 may include data including but not limited to access credentials for access to a network such as a WiFi network or Bluetooth network, MAC addresses, Bluetooth addresses, data used for configuring headset one 201, headset two 202 or both, to recognize and link with each other without user intervention and/or without intervention by client device 210, assigning a master/slave relationship between headsets one and two (201, 202) (e.g., headset 201 may be the master and headset 202 may be the slave, or vice-versa), determine a type of radio and/or a wireless protocol (e.g., BT, BTLE, NFC, WiFi, etc.) to use for one or more of the links 207, 208, 214, etc., for example. Configuration (CFG) 321 may be a file stored in a data store of the wireless headset (e.g., in data storage 320). Configuration (CFG) 321 may include data, executable instructions or both.

RF system 330 may include one or more antennas 333 coupled with one or more radios 331. Wireless links denoted as 335, between headsets one and two (201, 202) and wireless links between the client device 210 and headset one 201, headset two 202 or both, may be handled by the same or different radios 331. Different radios 331 may be coupled with different antennas 333 (e.g., one antenna for NFC, another antenna for WiFi, and yet another antenna for Bluetooth).

I/O system 360 may include a port 365 for a wired connection with an external device such as an Ethernet network, a client device, USB port, charging device for charging a rechargeable battery in power supply 370, for example. As one example, port 365 may constitute a micro or mini USB port for wired communications and/or wired charging (e.g., by an AC or DC charging system). As another example, port 365 may constitute a plug such as a TRS or TRSS plug (e.g., an audio jack or mini-plug).

Power supply 370 may source one or more voltages for systems in headsets one and two (201, 202) and may include a rechargeable power source, such as a Lithium Ion type of battery, for example. As will be described below, a switch/button 361 in I/O system 360 or other location may be activated by the user 260 to power up or otherwise bring headsets one and two (201, 202) online and in a state of readiness for use.

Audio system 340 may include a plurality of transducers and their associated amplifiers, preamplifiers, and other circuitry. The plurality of transducers may include one or more speakers 343 which may be coupled with one or more amplifiers 345 which drive signals to speaker 343 to generate sound 347 that is acoustically coupled into the ear (251, 252). Multiple speakers 343 may be used, to reproduce different frequency ranges (e.g., bass, midrange, treble), for example, and those multiple speakers 343 may be coupled with the same or different amplifiers 345 (e.g., bi-amplification, tri-amplification).

The plurality of transducers may also include one or more microphones 342 or other types of transducer that may convert mechanical energy (e.g., vibrations in skin and/or bone 346, ambient sound and/or speech 344) into an electrical signal. A plurality of the microphones 342 may be configured into a microphone array. The plurality of transducers may include accelerometers, motion sensors, piezoelectric devices, or other type of transducer operative to generate a signal from motion, vibration, pressure changes, mechanical energy, etc. Microphones 342 or other types of transducers may be coupled with appropriate circuitry (not shown) such as preamplifiers, analog-to-digital-converters (ADC), digital-to-analog-converters (DAC), DSP's, analog and/or digital circuitry, for example. The appropriate circuitry may be included in audio system 340 and/or other systems such as logic/circuitry 350.

Headsets one and two (201, 202) may include identical or nearly identical systems as depicted in FIG. 3, or may include more, fewer, or different systems than depicted in FIG. 3. As one example, headsets (201, 202) may be identical makes and models of headset made by the same manufacture, in which case, systems in headsets one and two (201, 202) may likely be identical or nearly identical. On the other hand, headsets one and two (201, 202) may be different models from the same manufacture, in which case, there may be differences in one or more of the systems in headsets one and two (201, 202). Headsets one and two (201, 202) need not be from the same manufacturer. Processor(s) 310, audio system 340, Logic/Circuitry 350, CFG 321, ALGO 330, or some combination of the foregoing may be used to implement an active noise cancellation (ANC) mode of operation when both headsets (201, 202) are donned. Signals generated by a plurality of the transducers in audio system 330 (e.g., microphones 342) may be used to generate signals coupled with amplifier 345 and output as sound 347 which may include the audio data and ANC data operative to counter, cancel out, or attenuate ambient sound 344 and/or vibrations 346. As one example, the signals generated by a plurality of the transducers in audio system 330 (e.g., microphones 342) may be processed by circuitry (e.g., circuits coupled with a DSP executing one or more algorithms) in one or both headsets (201, 202) to generate an anti-noise signal that may be coupled with amplifier 345 to implement active noise cancellation in the ANC mode.

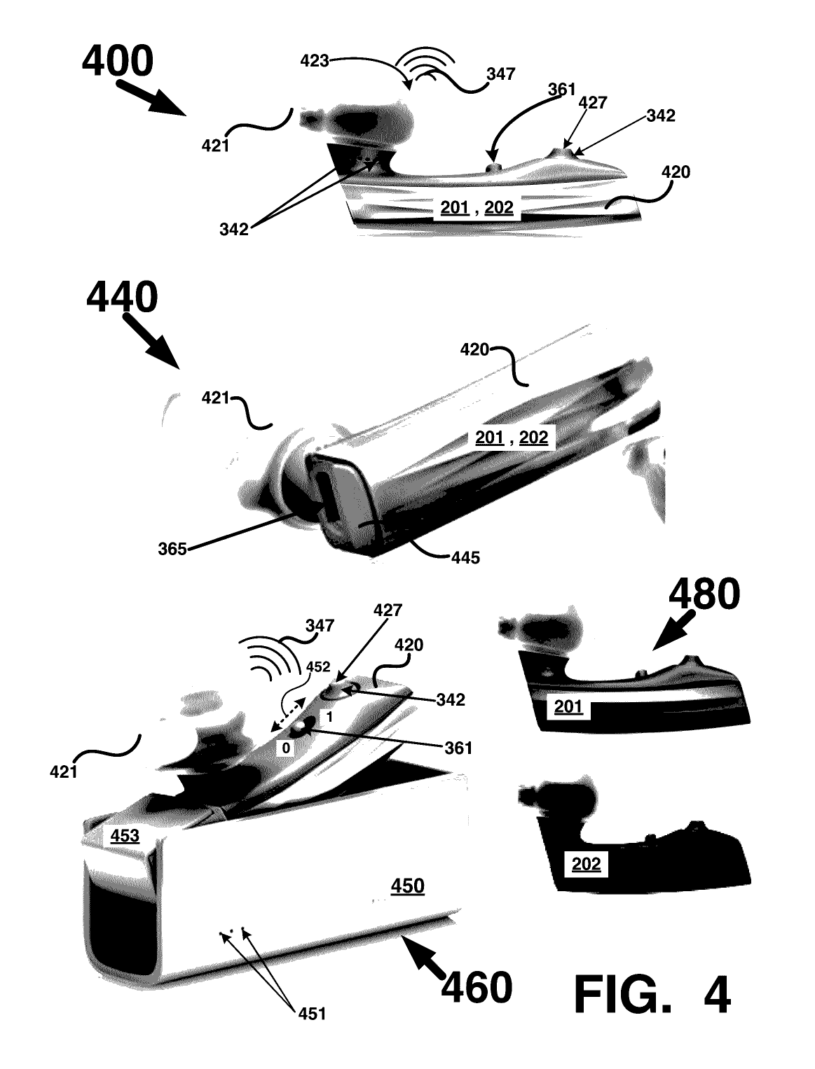

FIG. 4 depicts different views 400-480 of a wireless headset and associated components. Here, associated components of headsets one and two (201, 202) may include the aforementioned earpiece, earbuds, earloops, eartips, denoted as 421 in view 400. In side view 400, headsets one and two (201, 202) may include a chassis or housing denoted as 420 and may include functional structures, esthetic structures or both. An earpiece 421 may be used to couple headsets one and two (201, 202) with a portion of a user's ear. A portal or some other form of opening or aperture, denoted as 423 may provide a path for sound 347 to acoustically couple with the ear canal of the user's ear. Materials for the earpiece 421 may include but are not limited to rubber, silicone, plastics, synthetics, and medical grade materials, just to name a few, for example. The earpiece 421 may come in a variety of shapes, sizes, and configurations and is not limited to the example depicted in FIG. 4.

A switch or button, denoted as 361 may be actuated (e.g., by sliding from an “OFF” position to an “ON” position) to activate headsets one and two (201, 202). Activation of switch 361 may be used to establish a communications link or paring as described above in reference to stage 110 of FIG. 1. A plurality of transducers for the audio system 340 may include a transducer 342 having a surface 427 that is urged into contact with a skin surface of head 250 to sense vibrations in one or more of the skin, bone, or sub-dermal tissue of the head or face. Other transducers may include an array of transducers 342 (e.g., a microphone array) operative to detect sound related to speech or voicing and/or ambient noise from an environment the user 260 is positioned in. The transducers 342 in the array may be positioned behind portals formed in chassis 420, for example.

In partial profile view 440, headsets (201, 202) may include port 365 (e.g., a female micro USB port) for charging a rechargeable power source in power supply 370 and/or for wired data communications with an external device. A button 445 may be actuated by the user 260 to activate a functionality of headsets one and two (201, 202). For example, actuating button 445 may be operative to manually turn volume up or down on headsets one and two (201, 202). As another example, actuating button 445 may be operative to manually establish or terminate the wireless communications link 207 between the headsets (201, 202). As yet another example, actuating button 445 may be operative to cause headsets one and two (201, 202) to audibly report system status, such as how many hours of talk time remain based on current battery reserves. Actuation of button 445 may be operative to cause headsets one and two (201, 202) to switch from one content stream to different content stream (e.g., switch between telephone calls being handled by client device 210). Actuation of button 445 may be operative to cause headsets one and two (201, 202) to mute volume or reduce volume on audio data being presented by the headsets.

In partial rear profile view 460 headsets one and two (201, 202) may be docked in a charging platform 450 that may include a rechargeable power source (e.g., a Li-Ion battery) that charges a rechargeable power source (e.g., another Li-Ion battery) in the power supply 370 via a connector (not shown) positioned in a docking structure 453 (e.g., a male micro USB connector) and operative to mate with port 365. Charging platform 450 may include an indicator 451 operative to show an amount of charge available in the battery of the charging platform 450 to recharge the power system of headsets one and two (201, 202). In this view, switch 361 may be actuated 452 from an “Off” position denoted a “0” to an “On” position denoted as “1” to activate (e.g., power up) headsets one and two (201, 202). Headsets one and two (201, 202) may be de-activated by actuating 452 the switch 361 from the “1” position to the “0” position.

In a side view 480, headset one 201 may be an identical make and/or model as headset two 202; however, color or some other ornamental feature may be used to distinguish between headsets one and two (201, 202). As one example, headset one 201 may be the color “Red” and may be donned on a right ear; whereas, headset two 202 may be the color “Black” and may be donned on a left ear.

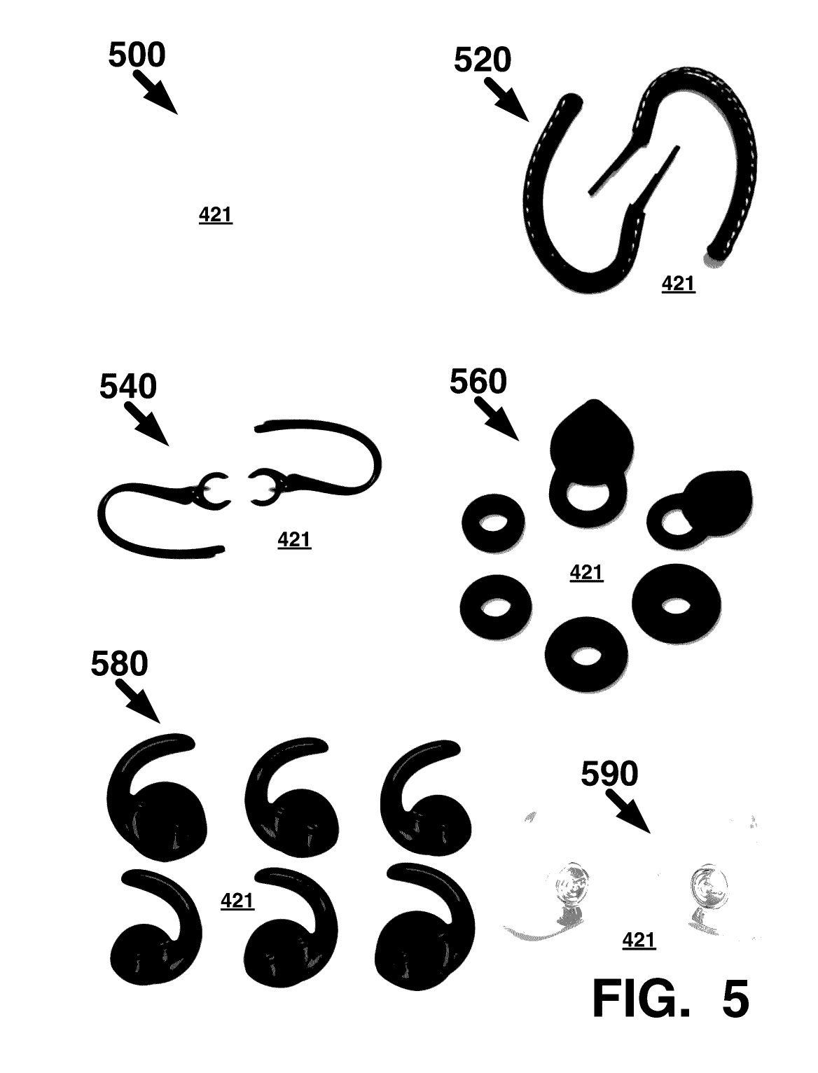

FIG. 5 depicts different examples 500-590 of earpieces that may be used with a wireless headset. Earpieces 421 may be custom fit as in example 590 (e.g., custom ear molds fitted by an Audiologist or a Doctor of Otology) or be supplied by a manufacturer or OEM. In examples 520 and 540, the structures depicted may be used in conjunction with and/or as accessories for earpiece 421. Actual configurations for earpiece 421 will be application dependent and are not limited to the examples depicted herein.

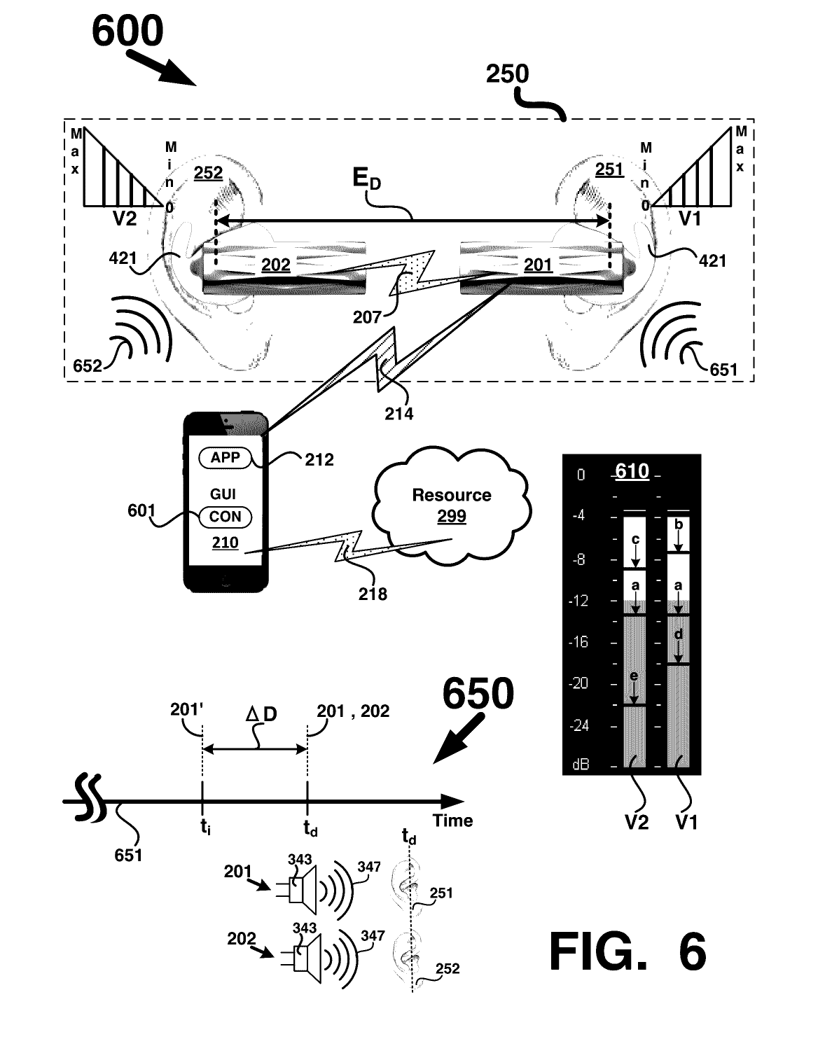

FIG. 6 depicts an example of a pair of donned wireless headsets and examples of volume levels for each wireless headset. In FIG. 6, a head 250 (e.g., of a user 260) is depicted in dashed line. Wireless headsets one and two (201, 202) when donned on ears (251, 252) on head 250, may be spaced apart approximately by the ear separation distance E_{D} (e.g., E_{D} may vary with head shapes and/or sizes). Ear separation distance E_{D} may be measured from some reference point on the ears (251, 252) or the wireless headsets (201, 202), for example. As one example, the ear separation distance E_{D} may be measured from a center of the portals 423 of the earpieces 421.

In FIG. 6, as data representing the content (CON) 601 from client device 210 is being transmitted 214 to headset one 201, which is wirelessly linked 207 with headset two 202. Ambient noise levels for sound 651 and/or 652 that is incident on headsets one and two (201, 202) may require volume adjustments in the audio systems 330 or one or both headsets (201, 202). Each of headsets one and two (201, 202) may have its volume V1 for 201 and V2 for 202, adjusted from some minimum value of “0” to some maximum value “Max” (e.g., 0 dB), or vice-versa, in response to the ambient noise levels 651 and/or 652. A sound level graph 610 depicts several examples of how volume levels may be adjusted (e.g., up or down) in one or both headsets (201, 202). As one example, in general, or in response to ambient noise levels (651, 652), headset one 201, headset two 202 or both, may have their respective volumes (V1, V2) set to approximately the same level (e.g., in dB's) as denoted by the arrows for “a” in graph 610. Here, headset one 201 may set and/or control its own volume level V1 and the volume level V2 of headset two 202, or headset two 202 may set and/or control its volume level V2 and the volume level V1 of headset one 201.

As another example, if ambient noise level 652 at headset two 202 is higher than the ambient noise level 651 at headset one 201, then volume V2 in headset two 202 may be adjusted to a higher level denoted by arrow “C”, while the volume level V1 of headset one 201 may remain at the same level or be adjusted downward to a lower level, such as the level “a”. Similarly, if ambient noise level 651 at headset one 201 is higher than the ambient noise level 652 at headset two 202, then volume V1 in headset one 201 may be adjusted to a higher level denoted by arrow “d”, while the volume level V2 of headset two 202 may remain at the same level or be adjusted downward to a lower level, such as the level “a”. As yet another example, volume levels V1 and V2 may not be equal and may change dynamically relative to each other as denoted by arrows for “d” and “e” in graph 610. Volume levels V1 and V2 may be controlled (e.g., proportioned in level) by headset one 201 only, headset two 202 only, or both headsets (201, 202). In some examples, APP 212 and/or GUI on client device 210 may control V1, V2 or both.

Although speech has been described as one form of the audio data that is presented on the headsets (201, 202), other content such as media, music, multi-channel sound, multi-channel sound, soundtracks, or other may be presented on the headsets (201, 202). APP 212 and/or one or both of the headsets (201, 202) may determine which channels in content having multiple channels, is presented in which headset, such that some channels may be presented in headset one 201 and other channels in headset two 202. In some examples, all channels may be presented in both headsets (201, 202). Volume levels of one or more of the channels may be adjusted as described above and the adjustments may be in response to ambient noise. Latency in multi-channel content may be addressed as described below in reference to diagram 650 in FIG. 6, by applying a time delay (e.g., ΔD) on a per channel basis.

In FIG. 6, diagram 650 depicts one example of how one or both of the headsets (201, 202) may alter time synchronization of the audio (e.g., audio included in the audio data) being presented to the ears (251, 252) of the user 260. As was described above, latency in transmission of the audio data over link 207 from headset one 201 to headset two 202 may result in an audibly perceptible time delay between sound 347 as heard through both ears (251, 252). For example on an audio time axis 651, audio data may be presented on headset one denoted as 201′ at a time denoted as tᵢ (e.g., an initial time without delay), and on headset two 202 at a later time denoted as t_{d} (e.g., at a time delay later). Headset 201, 202 or both may determine if a latency exists (e.g., by calculating latency based on ping time or other metric), and using the link 207, command that a delay (e.g., in milliseconds, microseconds, etc.) be added to presentation of the audio data on the headset that would otherwise present the audio data at an earlier time (e.g., headset one 201′ at time tᵢ). If the calculated latency is zero or below a predetermined value that does not affect auditory intelligibility, then a time delay may not be added. Here a delay of ΔD may be added to presentation of the audio data on headset one 201 such that at the time t_{d} (e.g., t_{d}=tᵢ+ΔD) speakers 343 in headsets (201, 202) emit sound 347 at approximately the same time so that the audio data is acoustically communicated to each ear (251 and 252) in time synchronization and without an audibly (e.g., from a standpoint of the user 260) perceptible time delay. Delay ΔD may be calculated by headset 201, 202 or both and may be included in data that is transmitted along with the audio data, such as in a field of a data packet assigned for the delay ΔD, for example. As described above, delay ΔD may be calculated based on ping time, where delay ΔD may constitute a fraction of the ping time in a range from 0 to 1 where 0 may be zero delay and 1 may be maximum delay. For example, if the ping time is calculated (e.g., by headset one 201) t0 be approximately 40 milliseconds, and the fraction is approximately 0.4, then delay ΔD≈0.4*40 ms≈16 ms.

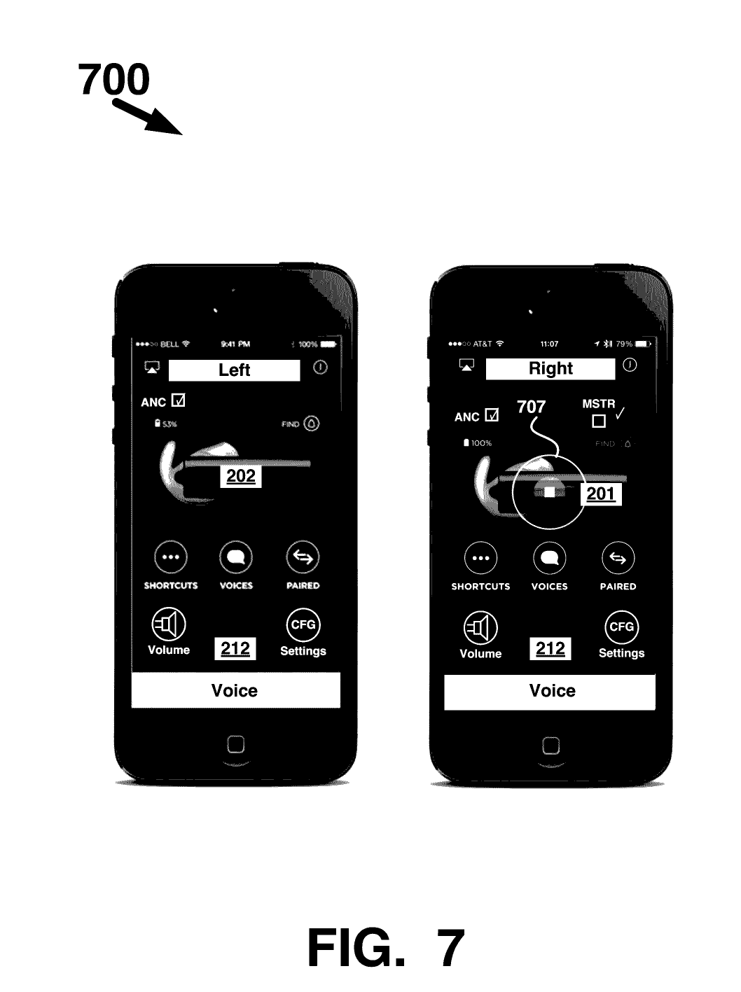

FIG. 7 depicts one example 700 of an application for a pair of wireless headsets (201, 202). In FIG. 7, an application denoted as APP 212 may have the same or different screens for wireless headsets (201, 202), for purposes of explanation, a different screen is depicted for each headset 202 (e.g., red in color for Left ear 252) and 201 (e.g., black in color for Right ear 251). Headset 201 may be configured to be the master head set as denoted by icon MSTR □ with a check in it. An active noise cancellation mode has been activated on both wireless headsets (201, 202) as denoted by icon ANC □ with a check in it. Icon 707 denotes that headset 201 is wirelessly linked with headset 202. Battery reserve icons on both screens may indicate a power level of the power supplies in each headset (201, 202) such as 53% in 202 and 100% in 201. Other icons that may be displayed on the GUI of APP 212 include but are not limited to paring status, settings, and volume controls. A volume icon may be activated to set the volume of headsets 201, 202 or both as described above, and may also be used to activate or deactivate the ANC mode. A settings icon may be used to configure each headset and to select one of the headsets as the master headset such that the above mentioned MSTR □ icon with a check in it will appear on the screen for that headset. Some or all of the options selected from the settings may be used for the CFG 321 which may be stored in non-volatile memory of each headset (e.g., in data storage 320). Settings may be used to determine which wireless communication protocol(s) will be used for the wireless communications link 207 between headsets and other wireless links, such as 214, for example. Settings may also be used to determine what types of content are presented to each headset, which channels of content are presented to each headset, etc. A finger swipe or other gesture on touch screen of client device 210 may be used to move between the screens for headset 201 and 202, for example. The screens for headset 201 and 202 may display the type of content the headsets are configured to act on, such as Voice from a telephonic or VoIP conversations, for example. Actual configurations and appearance of the GUI and functionality of APP 212 may be application dependent and may be different for different operating systems (OS) of client device 210, such as Android OS® for some devices, iOS® for other devices, or Windows Phone® for yet other devices, for example.

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A system of wearable wireless devices for enhancing auditory intelligibility, comprising:
a pair of discrete wireless headsets including
a first wireless headset having a first radio and a first speaker, and
a second wireless headset having a second radio and a second speaker,
the first wireless headset configured to establish a wireless communications link with the second radio, after detecting, using the first radio, a radio frequency signal transmitted by the second radio,
the first wireless headset configured to receive data representing content and to transmit, using the first radio, audio data included in the data representing the content to the second radio via the wireless communications link,
the first wireless headset configured to determine a latency, if any, in transmitting the audio data and receiving from the second wireless headset an acknowledgement signal indicating that the audio data was received by the second wireless headset, and
the first wireless headset configured, when the latency is determined, to calculate a time delay to delay playback of the audio data on the first speaker.

2. The system of claim 1, wherein the data representing the content is received from a data store internal to the first wireless headset.

3. The system of claim 1, wherein the data representing the content is wirelessly received via a first wireless communications link between the first wireless headset and an external wireless computing device.

4. The system of claim 1, wherein the data representing the content is received via a wired communications link between the first wireless headset and an external device.

5. The system of claim 1 and further comprising:
a first microphone included in the first wireless headset; and
a second microphone included in the second wireless headset, and
wherein playback volume of the audio data in the first speaker, the second speaker or both, is increased volume or decreased volume in response to ambient acoustic energy incident on the first microphone, the second microphone or both.

6. The system of claim 5, wherein the playback volume of the audio data in the first speaker is different than the playback volume of the audio data in the second speaker.

7. The system of claim 6, wherein playback of the audio data in the first speaker is delayed in time by the time delay.

8. The system of claim 5, wherein the playback volume of the audio data in the first speaker and the playback volume of the audio data in the second speaker are approximately equal to each other.

9. The system of claim 8, wherein playback of the audio data in the first speaker is delayed in time by the time delay.

10. The system of claim 5, wherein a first signal from the first microphone, a second signal from the second microphone or both, are processed by at least one processor to generate an anti-noise signal that is applied to the first speaker, the second speaker or both, when the at least one processor receives a signal configured to activate an active noise cancellation mode.

11. The system of claim 1, wherein the first wireless headset and the second wireless headsets are configured to wirelessly communicate with each other via the wireless communications link when the first wireless headset and the second wireless headset are spaced apart from each other by a distance of about 25 cm or less.

12. The system of claim 1, wherein the first wireless headset, the second wireless headset or both include an earpiece configured to be ear-donned.

13. A wireless device for enhancing auditory intelligibility, comprising:
a wireless headset having a radio and a speaker, the wireless headset configured to
establish a wireless communications link with an external radio, after detecting, using the radio, a radio frequency signal transmitted by the external radio,
receive data representing content and to transmit, using the radio, audio data included in the data representing the content to the external radio via the wireless communications link,
determine a latency, if any, in transmitting the audio data and receiving from the external radio an acknowledgement signal indicating that the audio data was received by the external radio, and
calculate, when latency is determined, a time delay to delay playback of the audio data on the speaker.

14. The wireless device of claim 13, wherein the external radio is included in an external wireless headset.

15. The wireless device of claim 14, wherein the wireless headset, the external wireless headset or both include an earpiece configured to be ear-donned.

16. The wireless device of claim 13, wherein the wireless headset is configured to wirelessly communicate with the external radio via the wireless communications link when the wireless headset and the external wireless headset are spaced apart from each other by a distance of about 25 cm or less.

17. A method for enhancing auditory intelligibility, comprising:
receiving data representing content at a first wireless headset;
detecting, wirelessly, a radio frequency signal from a second wireless headset;
establishing a wireless communication link between the first wireless headset and the second wireless headset, the establishing occurring automatically after the detecting;
transmitting, using the wireless communications link, audio data included in the data representing the content, from the first wireless headset to the second wireless headset, the audio data;
determining a latency, if any, in transmitting the audio data and receiving from the second wireless headset an acknowledgement signal indicating that the audio data was received by the second wireless headset;
calculating, on the first wireless headset, when latency is determined, a time delay; and
delaying playback of the audio data on the first wireless headset by the time delay.

18. The method of claim 17 and further comprising:
sensing ambient acoustic energy incident on the first wireless headset, the second wireless headset or both; and
adjusting, based on the ambient acoustic energy, a volume of playback of the audio data on the first wireless headset, on the second wireless headset or both.

19. The method of claim 18 and further comprising:
receiving at a processor, a signal configured to activate an active noise cancellation mode;
processing on the processor, an output signal from a microphone;
generating, using the processor, an anti-noise signal from the output signal; and
applying the anti-noise signal to a first speaker in the first wireless headset, a second speaker in the second wireless headset or both.

20. The method of claim 17, wherein the establishing occurs automatically when the first wireless headset and the second wireless headset are spaced apart from each other by a distance of about 25 cm or less.
